(19) United States
(12) Patent Application Publication
(10) Pub. No.: US 2016/0004566 A1
(43) Pub. Date: Jan. 7, 2016

(54) EXECUTION TIME ESTIMATION DEVICE AND EXECUTION TIME ESTIMATION METHOD

(71) Applicant: FUJITSU LIMITED, Kawasaki-shi, Kanagawa (JP)

(72) Inventors: Yusuke KUCHIWAKI, Nagoya (JP); Shoichi KOGISO, Nagoya (JP); Takamasa OHASHI, Toyoake (JP); Masakazu FURUKAWA, Yoro (JP); Takashi IKEZAKI, Yatomi (JP)

(73) Assignee: FUJITSU LIMITED, Kawasaki-shi, Kanagawa (JP)

(21) Appl. No.: 14/730,600

(22) Filed: Jun. 4, 2015

(30) Foreign Application Priority Data
Jul. 2, 2014 (JP) 2014-136433

(51) Int. Cl. G06F 9/48

(52) U.S. Cl. CPC G06F 9/4881

(57) ABSTRACT

A device includes: a memory configured to store a condition of exclusive execution for a plurality of processes, and execution time ranges of each of one or more modules, the execution time ranges indicating from a shortest estimation time to a longest estimation time regarding; and a processor configured to estimate an entire execution time by executing estimation processing so as to cause simulation of the estimation processing to progress, the estimation processing including: generating one or more cases, for each of the plurality of processes, in order of the one or more modules based on the execution time ranges, determining whether there is a possibility that exclusion waiting occurs based on the condition, for each of the one or more cases, and setting the exclusion waiting for a certain case in which it is determined that there is the possibility, from among the one or more cases.

### CROSS-REFERENCE TO RELATED APPLICATION

This application is based upon and claims the benefit of priority from the prior Japanese Patent Application No. 2014-136433, filed on Jul. 2, 2014, the entire contents of which are incorporated herein by reference.

### FIELD

The embodiments discussed herein are related to a technology for estimating an execution time in a case of executing of a plurality of workflows.

### BACKGROUND

In a data center, numerous information technology devices (IT devices) such as servers, storage, and networks are provided. In addition, the IT devices are obtained by combining hardware, operating systems (OS), and middleware, with software applications to execute desired processing. In addition, in the data center, a plurality of business systems constituted by combining a plurality of IT devices operates, and monitoring and maintenance tasks are performed on the plurality of IT devices and the business systems.

There exist technologies that automate operations in such a data center, and in a certain technology, a workflow in which a procedure for a business system is described is designed and automatically executed so that optimization of the business is achieved. As illustrated in FIG. 1, it is assumed that components that correspond to tasks to be done have been prepared in advance and are arranged and executed from “Start” to “End”.

However, due to simultaneous execution of operation processes, complicated branching in a workflow, and the like, the execution of the operation processes may not be completed on schedule, thereby affecting subsequent tasks. The operation process is an instance generated by applying information such as a parameter to a workflow and starting the workflow. For example, the start of subsequent tasks, such as in an online task, may be delayed.

As described above, when the operation process is not executed on schedule, thereby affecting subsequent tasks, it is desirable that the appropriate end time of the operation process is determined in advance.

For example, there exists a technology in which human tasks are made into a workflow, and it is predicted whether or not an operation process being executed will be completed by a target time. The above-described related art has been discussed, for example, in Japanese Laid-open Patent Publication No. 8-190584, Japanese Laid-open Patent Publication No. 2008-84083, Japanese Laid-open Patent Publication No. 2009-169787, Japanese National Publication of International Patent Application No. 2003-526158, and the like.

### SUMMARY

According to an aspect of the invention, a device for estimating an entire execution time when a plurality of processes, each of which includes one or more modules, is executed, the device includes: a memory configured to store a condition of exclusive execution for the plurality of processes, and execution time ranges of each of the one or more modules, the execution time ranges indicating from a shortest estimation time to a longest estimation time regarding each of execution times by the one or more modules; and a processor configured to estimate the entire execution time by executing estimation processing so as to cause simulation of the estimation processing to progress, the estimation processing including: generating one or more cases, for each of the plurality of processes, in order of the one or more modules based on the execution time ranges of each of the one or more modules, determining whether there is a possibility that exclusion waiting occurs based on the condition, for each of the one or more cases, and setting the exclusion waiting for a certain case in which it is determined that there is the possibility, from among the one or more cases.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a workflow;

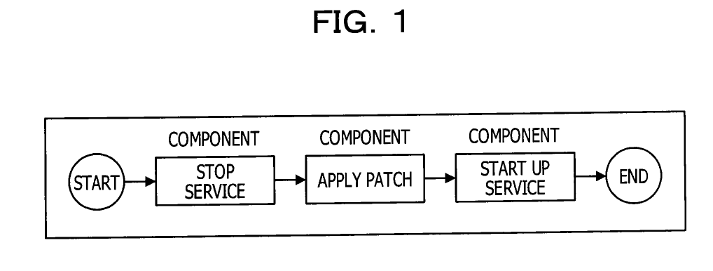

FIG. 2 is a functional block diagram of an information processing device according to an embodiment;

FIG. 3 is a diagram illustrating a main processing flow of an execution control unit;

FIG. 4 is a diagram illustrating an output example of a processing result;

FIG. 5 is a diagram illustrating a processing flow of calculation processing;

FIG. 6 is a diagram illustrating an example of a start management table;

FIG. 7 is a diagram illustrating a main processing flow of an operation process state management unit;

FIG. 8 is a diagram illustrating a processing flow of update processing;

FIG. 9 is a diagram illustrating a first example of a workflow;

FIG. 10 is a diagram illustrating an exclusion management table in the first example of the workflow;

FIG. 11 is a diagram illustrating an execution time management table in the first example of the workflow;

FIG. 12 is a diagram illustrating the state of an instance management table at “t=0” in the first example of the workflow;

FIG. 13 is a diagram illustrating the state of the instance management table at “t=1” in the first example of the workflow;

FIG. 14 is a diagram schematically illustrating the state of the instance management table;

FIG. 15 is a diagram illustrating the state of the instance management table at “t=2” in the first example of the workflow;

FIG. 16 is a diagram schematically illustrating the state of the instance management table;

FIG. 17 is a diagram schematically illustrating the state of the instance management table;

FIG. 18 is a diagram schematically illustrating the state of the instance management table;

FIG. 19 is a diagram illustrating a processing flow of state decision processing;

FIG. 20 is a diagram illustrating a processing flow of waiting state checking processing;

FIG. 21 is a diagram illustrating a second example of workflows;

FIG. 22 is a diagram illustrating an exclusion management table in the second example of the workflows;

FIG. 23 is a diagram illustrating an execution time management table in the second example of the workflows;

FIG. 24 is a diagram illustrating the state of the instance management table at “t=0” in the second example of the workflows;

FIG. 25 is a diagram illustrating the state of the instance management table at “t=1” in the second example of the workflows;

FIG. 26 is a diagram schematically illustrating the state of the instance management table;

FIG. 27 is a diagram illustrating the state of the instance management table at “t=2” in the second example of the workflows;

FIG. 28 is a diagram schematically illustrating the state of the instance management table;

FIG. 29 is a diagram illustrating a third example of workflows;

FIG. 30 is a diagram illustrating an exclusion management table in the third example of the workflows;

FIG. 31 is a diagram illustrating an execution time management table in the third example of the workflows;

FIG. 32 is a diagram illustrating a start time management table in the third example of the workflows;

FIG. 33 is a diagram illustrating the state of the instance management table at “t=0” in the third example of the workflows;

FIG. 34 is a diagram illustrating the state of the instance management table at “t=1” in the third example of the workflows;

FIG. 35 is a diagram schematically illustrating the state of the instance management table;

FIG. 36 is a diagram illustrating the state of the instance management table at “t=2” in the third example of the workflows;

FIG. 37 is a diagram schematically illustrating the state of the instance management table;

FIG. 38 is a diagram illustrating the state of the instance management table at “t=3” in the third example of the workflows;

FIG. 39 is a diagram schematically illustrating the state of the instance management table;

FIG. 40 is a diagram illustrating the state of the instance management table at “t=4” in the third example of the workflows;

FIG. 41 is a diagram schematically illustrating the state of the instance management table;

FIG. 42 is a diagram illustrating an example of a fourth example of workflows;

FIG. 43 is a diagram schematically illustrating execution of the fourth example of the workflows; and

FIG. 44 is a hardware configuration diagram of a computer.

### DESCRIPTION OF EMBODIMENTS

In the process of predicting completion time in the related art, the end time is calculated by simply using information that defines an estimation of the task time, and information on an execution time of an identical task that has been previously performed. In the execution time, a time and a labor take too long for the measurement, and the execution time has been determined previously, so that a different result is obtained depending on an environment, thereby causing a problem of accuracy.

In addition, in the related art, an important characteristic of the operation process is not considered. That is, the execution time of an operation module changes depending on the situation of a server performing execution, but the minimum value and the maximum value may still be determined. Therefore, when there is merely a single operation process, the minimum value and the maximum value of the execution time of the operation process may be calculated from the minimum value and the maximum value of the execution time of an operation module. The operation module is a target for which the execution time is estimated when a component included in a workflow is run.

However, when a plurality of operation processes is executed, there is a case in which an exclusive condition exists among the plurality of operation processes. In such a case, an exclusion waiting time is defined according to timing at which the exclusion is resolved, but when exclusive conditions are set to overlap with each other, the plurality of exclusive conditions is affected by each other, so that it is difficult to determine when the exclusion is resolved, merely from an operation process that has caused the exclusion directly. That is, it is difficult to estimate the exclusion waiting time easily.

In addition, the occurrence of the exclusion also depends on execution timing data of the plurality of operation processes, but in the related art, such a problem is not solved.

Thus, an object of an embodiment of the technology discussed herein is to accurately estimate an execution time, even when an exclusive condition is defined when a plurality of workflows is executed.

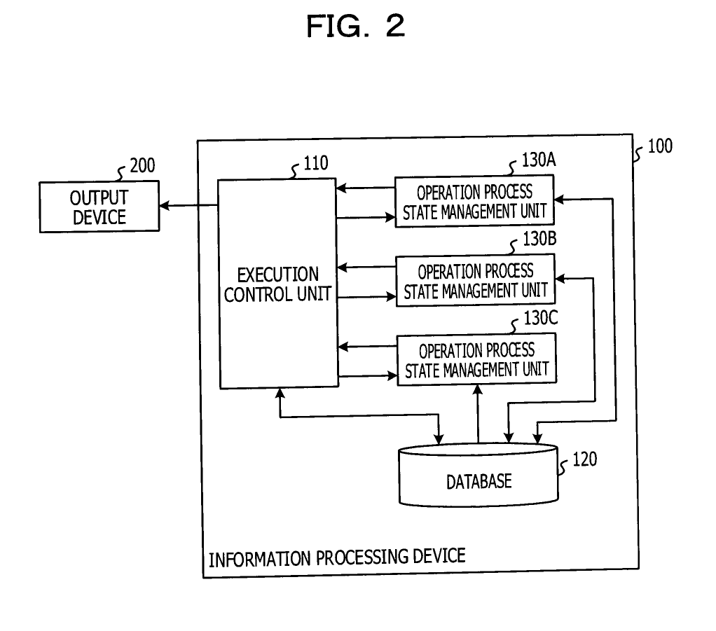

FIG. 2 illustrates a configuration example of an information processing device 100 according to an embodiment that operates as an execution time estimation device. The information processing device 100 according to the embodiment includes an execution control unit 110, a database 120, and operation process state management units 130 (operation process state management units 130A to 130C in FIG. 2) that are respectively started for the operation processes executed at the same time. In addition, the information processing device 100 is coupled to an output device 200, which is an additional computer coupled to a display device, a printing device, and a network.

The execution control unit 110 controls start-up, processing, and the like of the operation process state management units 130A to 130C, based on data stored in the database 120, and outputs a processing result to the output device 200.

Each of the operation process state management units 130A to 130C manages the state of an operation process of a workflow that the operation process state management unit manages by causing the operation process to progress based on an instruction from the execution control unit 110, and by causing the flow of the operation process to transition based on the data stored in the database 120.

The database 120 stores a table of an execution time (execution time management table) for each component included in the workflow. In addition, the database 120 stores a table of an exclusive condition between workflows (for example, exclusion management table). In addition, the database 120 stores a table of execution timing of the operation process of the workflow (for example, start management table). In addition, the database 120 stores a table used to manage the state of the operation process (for example, instance management table).

In the embodiment, when a plurality of operation processes is run in parallel, a case in which exclusion waiting occurs and a case in which exclusion waiting does not occur are checked within a prediction range (the shortest time to the longest time) of the execution times of operation modules, and the execution time is determined for each of the cases. In addition, when there is branching in the operation process, multiple end times are determined, so that the problem is solved by obtaining execution patterns cyclopaedically. In addition, there is a case in which a human task is performed immediately, and a case in which no part of the human task is done until the last moment of the deadline. Thus, the range of the end time from the shortest time to the longest time is set for the human task.

As described above, in the embodiment, in a case in which a plurality of operation processes is run at the same time, a simulation is run for each execution pattern to be generated. In such a simulation, an instance of the operation process is generated for each of the execution patterns to be generated, and a change in the state of the instance is checked at time intervals.

As described above, a plurality of operation processes operates to be related to each other, based on an exclusive condition. There is a possibility of exclusion waiting overlapping so that an operation process A waits for an operation process B to complete, and the operation process B waits for an operation process C to complete, so that, when a possibility of exclusion waiting occurring is detected, it is determined recursively whether or not, for an operation process by which there is a possibility that exclusion waiting may occur, there is a possibility that further exclusion waiting may occur.

Therefore, resolution of the exclusion waiting may be detected appropriately, so that the waiting time is assumed correctly as a result of the resolution, and the execution time may be estimated correctly.

As described above, the simulation is run for each of the execution patterns to be generated, so that the execution time may be estimated even for a combination of operation processes the execution performances of which are not yet determined as long as the prediction range of the execution time of each operation module or the like is set.

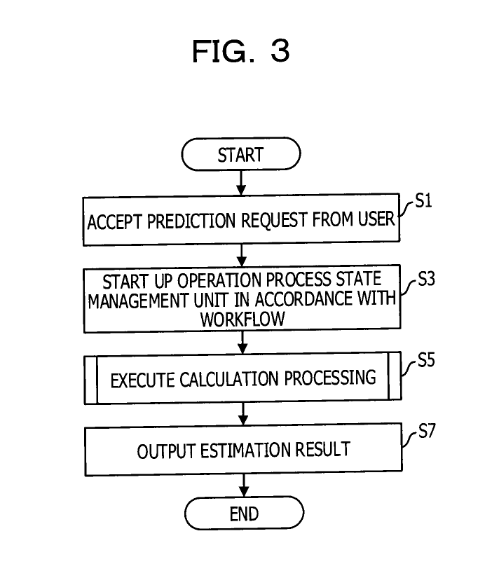

Operation content of the information processing device 100 is described below with reference to FIGS. 3 to 43.

First, operation of the execution control unit 110 is described with reference to FIG. 3.

The execution control unit 110 accepts a prediction request from a user (FIG. 3: Step S1). The prediction request includes a specification of workflows that are to be executed in parallel.

In addition, the execution control unit 110 starts the operation process state management units 130 in accordance with the workflows included in the prediction request (Step S3). For example, when three workflows are executed in parallel, the single operation process state management unit 130 is started for each of the workflows.

In addition, the execution control unit 110 or the like executes calculation processing (Step S5). The calculation processing is described below in detail.

In addition, as a result of the calculation processing, the execution control unit 110 outputs a calculation result to the output device 200 based on data stored in the database 120 (Step S7).

In the embodiment, data corresponding to the shortest execution time and data corresponding to the longest execution time are registered in the instance management table for each of the operation processes. When the start time is set, the shortest end time and the longest end time are also calculated.

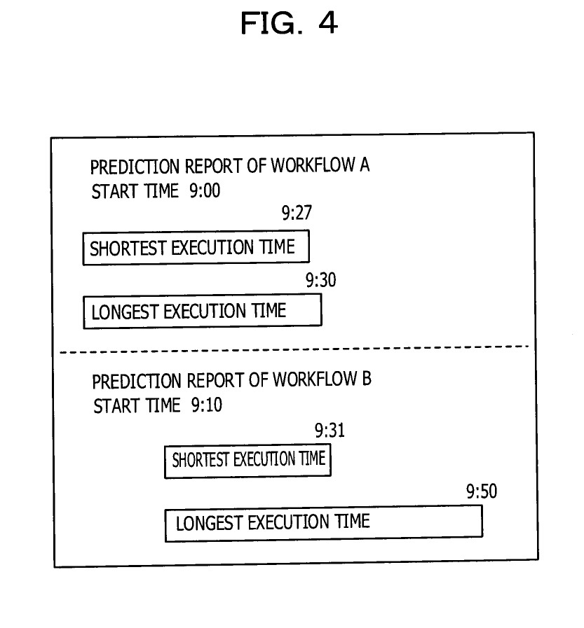

For example, examples of calculation results when a workflow A and a workflow B are executed at the same time are illustrated in FIG. 4. In the example of FIG. 4, the workflow A is started at 9:00, and the workflow B is started at 9:10. In such a case, in the workflow A, the shortest execution time is 0:27, so that the shortest end time is 9:27, and the longest execution time is 0:30, so that the longest end time is 9:30. On the other hand, in the workflow B, the shortest execution time is 0:21, so that the shortest end time is 9:31, and the longest execution time is 0:40, so that the longest end time is 9:50. As indicated by such a result, the execution ends by 9:50 at the latest when the workflows A and B are executed at the same time.

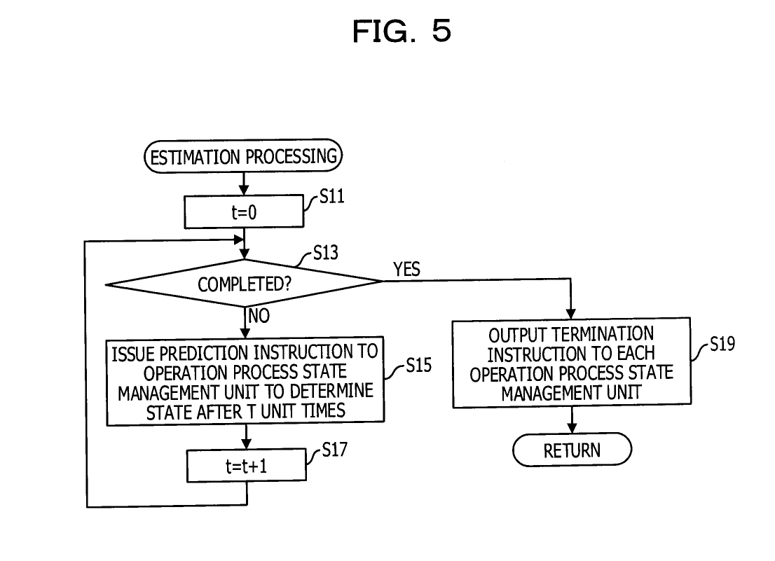

The calculation processing is described below with reference to FIG. 5.

First, the execution control unit 110 sets a time t at 0 (FIG. 5: Step S11).

In addition, the execution control unit 110 determines whether or not the processing is caused to end, depending on whether or not a notification indicating that all instances of the operation processes have been completed is received, from the started operation process state management units 130 (Step S13).

When the processing is not caused to end, the execution control unit 110 issues a prediction instruction to the operation process state management unit 130 to obtain the state after t unit times (Step S15). Here, the execution control unit 110 refers to the start management table stored in the database 120, and outputs the prediction instruction to the operation process state management units 130 managing workflows after the start time. In addition, the instruction is not issued to the operation process state management unit 130 that has received a notification indicating that all of the instances have been completed.

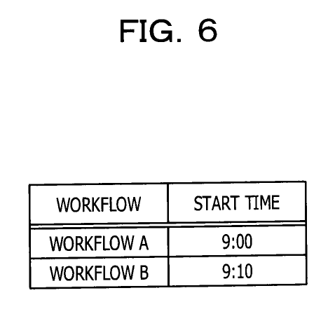

The start management table corresponds to, for example, the data illustrated in FIG. 6. In the example of FIG. 6, execution of the workflow A is started at 9:00, and execution of the workflow B is stated at 9:10. In such data illustrated in FIG. 6, the prediction instruction of Step S15 is not issued to the workflow B until 10 minutes after execution of the workflow A has started.

In addition, the execution control unit 110 increments “t” by 1 (Step S17), and the processing returns to Step S13. When such processing is executed, each of the operation process state management units 130 may be caused to record the state of the operation process at each of the times. When such processing is caused to end, the execution control unit 110 outputs an end instruction to each of the operation process state management units 130 (Step S19).

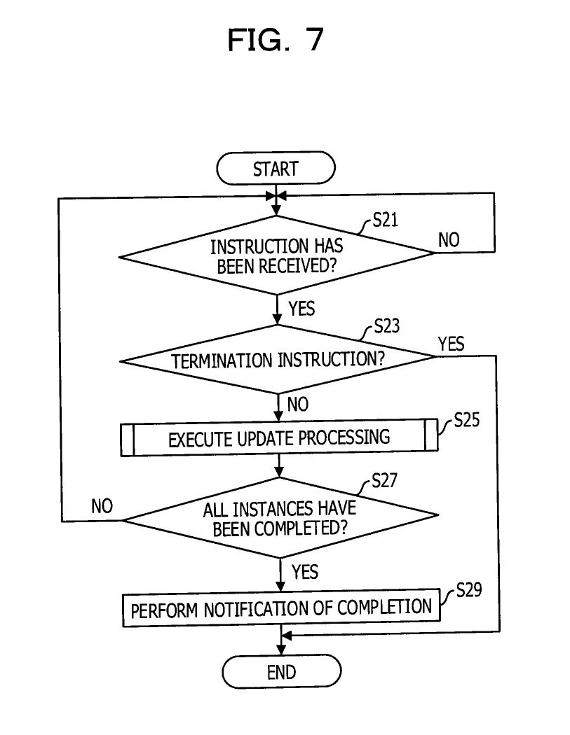

Processing content of the operation process state management unit 130 is described below with reference to FIGS. 7 to 43.

First, the operation process state management unit 130 determines whether or not an instruction has been received from the execution control unit 110 (FIG. 7: Step S21). When no instruction is received, the processing returns to Step S21 and waits to receive the instruction.

On the other hand, when an instruction has been received, the operation process state management unit 130 determines whether or not the instruction is an end instruction (Step S23). When the execution control unit 110 causes the calculation processing to end in the middle of the processing for some reason, there is a case in which an end instruction is issued. When the end instruction has been issued, the processing ends.

On the other hand, when the instruction is not an end instruction, the instruction is a prediction instruction, so that the operation process state management unit 130 executes update processing of the instance management table to perform registration of the state after the t unit times (Step S25). When such update processing is completed, the operation process state management unit 130 determines whether or not all instances of the operation process managed by the operation process state management unit 130 have been completed (Step S27). When at least one of the instances is being processed or is in a standby state, the processing returns to Step S21.

On the other hand, when all of the instances have been completed, the operation process state management unit 130 notifies the execution control unit 110 of the completion (Step S29). Then, the processing ends.

The instance management table may be updated, for each of the unit times, by such processing.

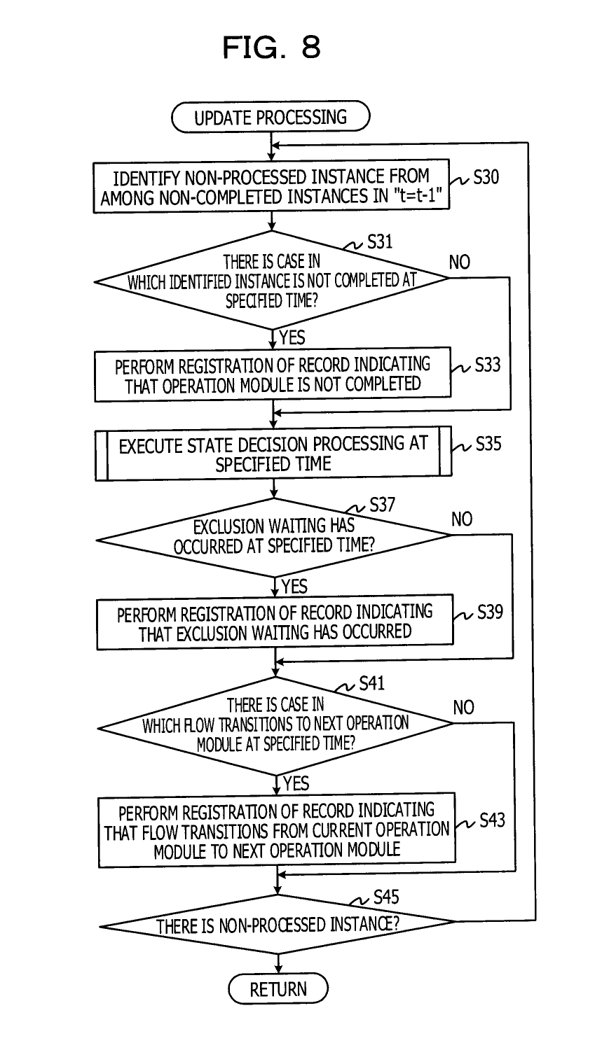

The update processing is described with reference to FIGS. 8 to 43. First, the operation process state management unit 130 identifies a single non-processed instance from among non-completed instances when “t=t−1” is satisfied in the instance management table (FIG. 8: Step S30).

Next, the operation process state management unit 130 determines whether or not there is a case in which the identified instance is not completed at a specified time (after the t unit times) (Step S31).

In a case in which the execution time of an operation module is set, for example, as one unit time, two unit times, or the like when the execution time of the operation module after “t−1” unit times (hereinafter referred to as elapsed time) is one unit time, the processing of the operation module is completed, or the operation module operates for a further unit of time. In such a case, it is determined that the identified instance is not completed at the specified time.

When the condition of Step S31 is satisfied, the operation process state management unit 130 creates, for the identified instance, a record indicating that the operation module is not completed, in the instance management table in the database 120 (Step S33).

On the other hand, when the condition of Step S31 is not satisfied, the processing proceeds to Step S35.

In addition, the operation process state management unit 130 executes state decision processing at the specified time (Step S35). The state decision processing is processing used to check the state of exclusion waiting, and is described later in detail.

Next, the operation process state management unit 130 determines, for the identified instance, whether or not exclusion waiting occurs at the specified time, based on the processing result of Step S35 (Step S37).

When it is determined that exclusion waiting has occurred, the operation process state management unit 130 creates, for the identified instance, a record indicating that the exclusion waiting has occurred, in the instance management table in the database 120 (Step S39).

On the other hand, when it is determined that exclusion waiting does not occur, the processing proceeds to Step S41.

In addition, the operation process state management unit 130 determines, for the identified instance, whether or not there is a case in which the flow transitions to the next operation module at the specified time (Step S41). For example, the operation process state management unit 130 determines whether or not there is a case in which execution of a certain operation module is completed when “t=t−1” is satisfied. The next operation module includes “End” as well.

When the condition of Step S41 is satisfied, the operation process state management unit 130 creates, for the identified instance, a record indicating that the flow transitions to the new operation module from the current operation module (or “Start”), in the instance management table in the database 120 (Step S43). Then, the processing proceeds to Step S45. On the other hand, even when the condition of Step S41 is not satisfied, the processing proceeds to Step S45. Then, the operation process state management unit 130 determines whether or not there exists a non-completed and non-processed instance when “t=t−1” is satisfied in the instance management table (Step S45). When there exists a non-completed and non-processed instance, the processing returns to Step S30. On the other hand, when a non-completed and non-processed instance does not exist, the processing returns to the processing of the calling source.

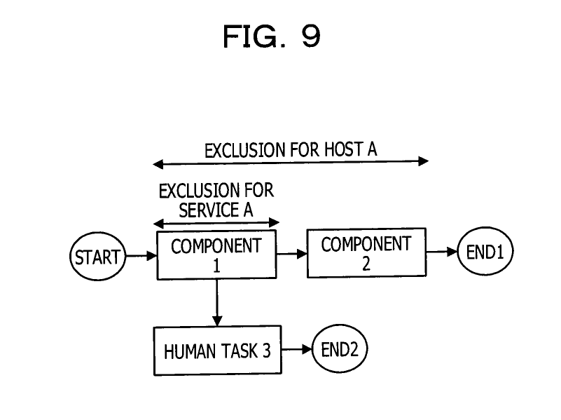

Here, for the sake of clarity of the processing content, a simple example is described. For example, a case in which a single workflow is executed is described below as an example. Here, the workflow as illustrated in FIG. 9 is assumed. That is, a component 1 is executed after the start, and a human task 3 and a component 2 are executed in parallel, after which execution ends. To the component 1, exclusion for service A is set, and to the components 1 and 2, exclusion for a host A is also set.

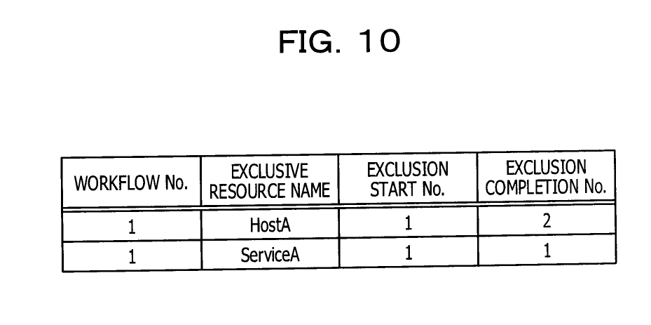

In such a case, in the database 120, the exclusion management table as illustrated in FIG. 10 is stored. In the example of FIG. 10, registration of a workflow number, an exclusive resource name (host A, service A, and the like), an exclusion start number (that is, component number), and an exclusion end number (that is, component number) is performed.

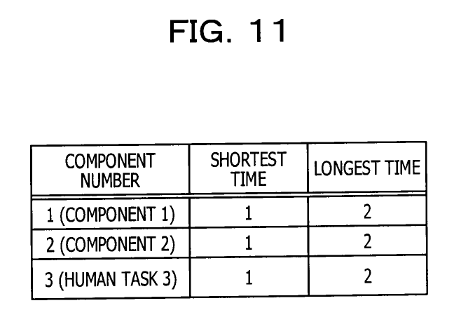

In addition, in the database 120, the execution time management table as illustrated in FIG. 11 is stored. In the example of FIG. 11, for each of the component numbers, the shortest time and the longest time are registered in the execution time management table. In such an example, the execution time is one second (in the specific example, one second is regarded as one unit time in order to simplify the description) or two seconds in any component. In a case of a human task, the execution time may be defined additionally. That is, setting in which the end timing of the human task comes after a further component has been completed may be performed additionally.

In the database 120, the start management table is stored, but a single workflow is applied to such an example, so that the start management table is not used here, and a description is omitted.

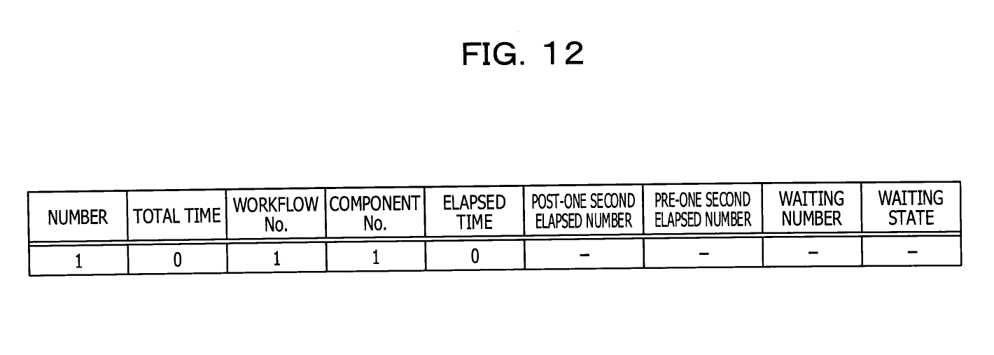

First, at “t=0”, the state of the instance management table becomes the state illustrated in FIG. 12. As illustrated in FIG. 12, it is assumed that, in the instance management table, an identification number of a record, a total time, a workflow number, a number of a component being executed, an elapsed time in the component, a post-one second elapsed record number, a pre-one second elapsed record number, a waiting number that is a record number for which exclusion waiting is caused to occur, and a waiting state that has been identified in the state decision processing are registered. At “t=0”, in Step S43, the state in which processing of the component 1 of a workflow 1 is not started is registered in the instance management table. That is, merely a single instance exists.

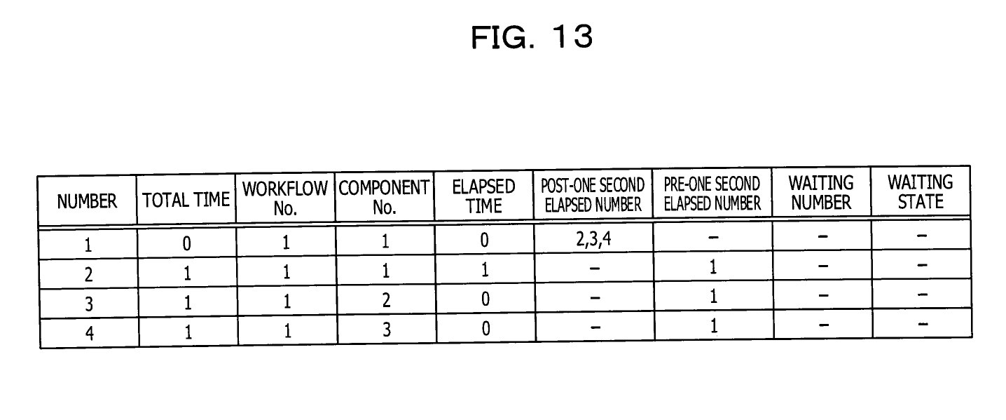

At “t=1”, the state of the instance management table becomes the state illustrated in FIG. 13. A record having a record number “2” indicates an instance when the processing of the component 1 is not completed, and is generated in Step S33, and the elapsed time is “1”. In addition, when the processing of the component 1 is completed in one second, the flow transitions to the component 2, or transitions to the component 3. Thus, in Step S43, a record having a record number “3” and a record having a record number “4” are generated.

In these records, “1” is set as the pre-one second elapsed record number, and in the records having the record number “1”, “2”, “3”, and “4” are set as the post-one second elapsed record number. The description is omitted herein, but the state transition may be traced bidirectionally due to registration of the pre-one second elapsed record number and registration of the post-one second elapsed record number.

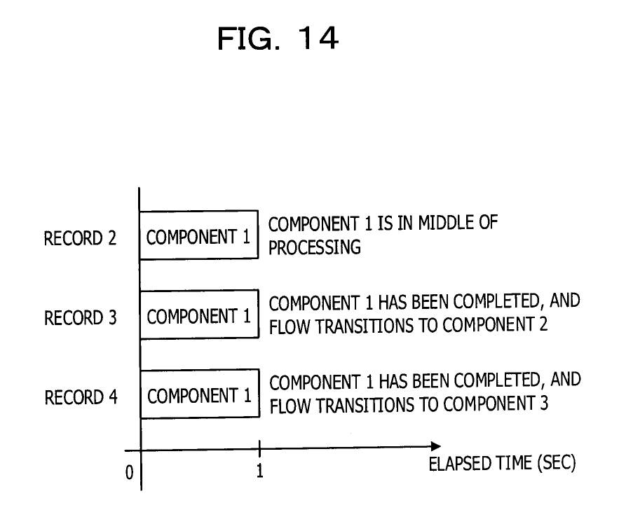

The state of such an instance management table is schematically illustrated in FIG. 14. It is assumed that an instance of the record “1” is branched into three instances.

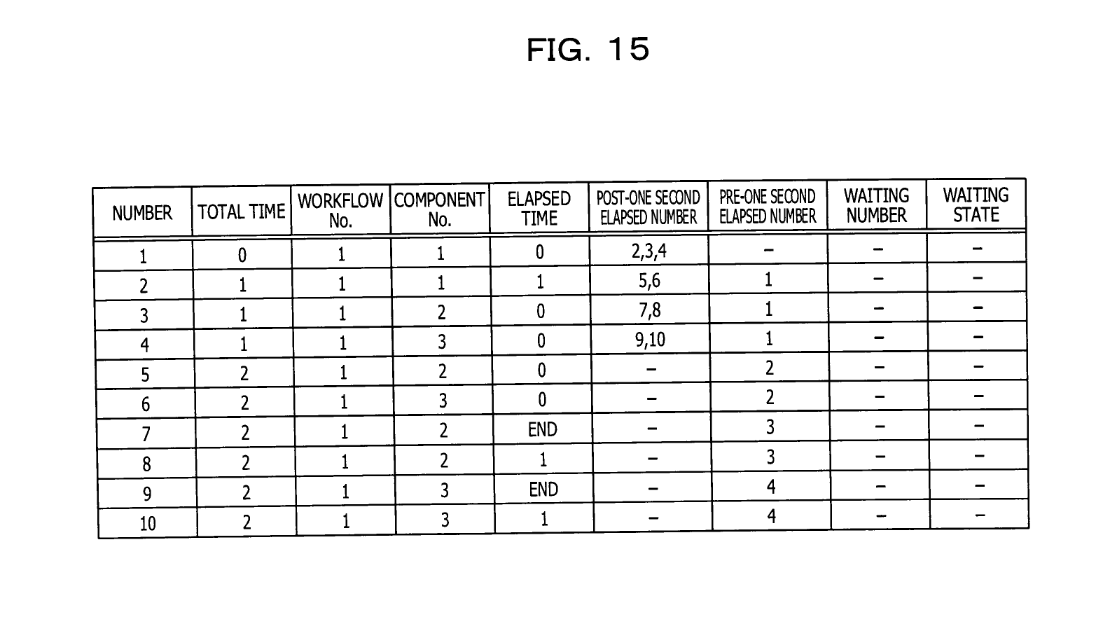

At “t=2”, the state of the instance management table becomes the state illustrated in FIG. 15. In the instance indicated by the record having the record number “2”, it is assumed that the processing of the component 1 is completed, so that creation of records indicating that the flow transitions to the next operation module in Step S43 is performed. In this case, due to the structure of the workflow 1, it is understood that the flow transitions to the component 2 or 3, and records having record numbers “5” and “6” are generated. The flow has just transitioned to the component 2 or 3, so that the elapsed time is “0”.

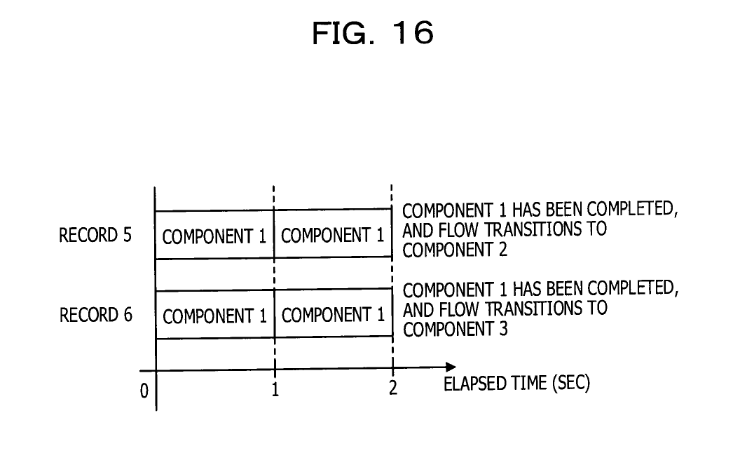

The state indicated by these records is schematically illustrated in FIG. 16. As described above, a case in which the flow transitions to the component 2 (record “5”) and a case in which the flow transitions to the component 3 (record “6”) occur after the component 1 has been completed in two seconds.

In addition, in the instance indicated by the record having the record number “3”, there occurs a case in which the processing of the component 2 ends to be completed in one second, and a case in which the processing of the component 2 is continued. In the former case, a record having a record number “7” is generated in Step S43, and in the latter case, a record having a record number “8” is generated in Step S33.

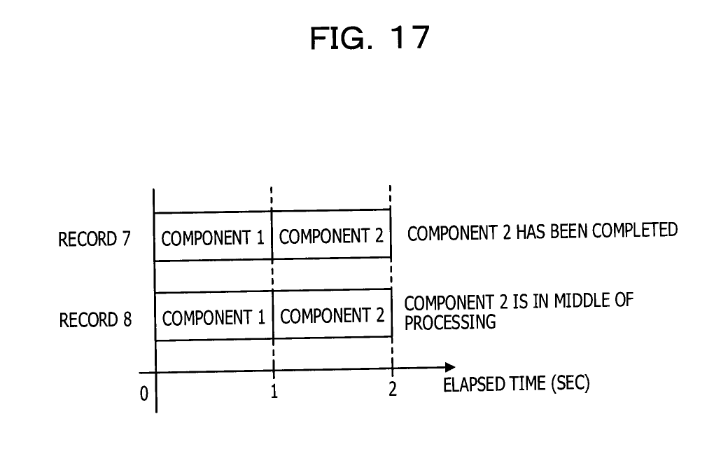

The state indicated by these records is schematically illustrated in FIG. 17. As described above, the case in which the processing of the component 2 ends to be completed in one second (record “7”), and the case in which the processing of the component 2 is continued for a further one second (record “8”) occur.

In addition, in the instance indicated by the record having the record number “4”, a case in which the processing of the component 3 ends to be completed in one second, and a case in which the processing of the component 3 is continued occur. In the former case, a record having a record number “9” is generated in Step S43, and in the latter case, a record having a record number “10” is generated in Step S33.

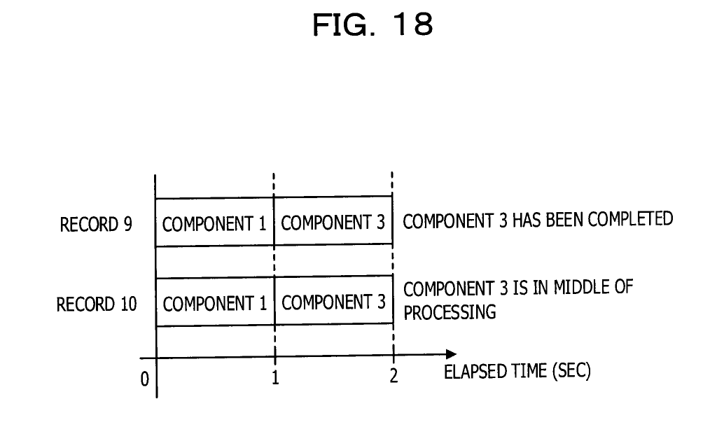

The state indicated by these records is schematically illustrated in FIG. 18. As described above, the case in which the processing of the component 3 ends to be completed in one second (record “9”), and the case in which the processing of the component 3 is continued for one second (record “10”) occur.

As described above, at “t=2”, it is assumed that the three instances are branched into six instances. In the subsequent times, the same processing is repeated, and the description is omitted herein.

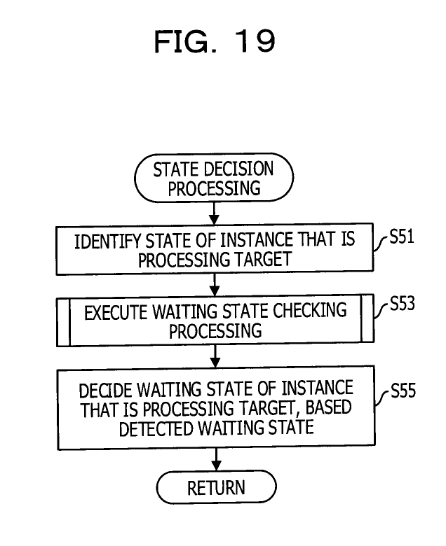

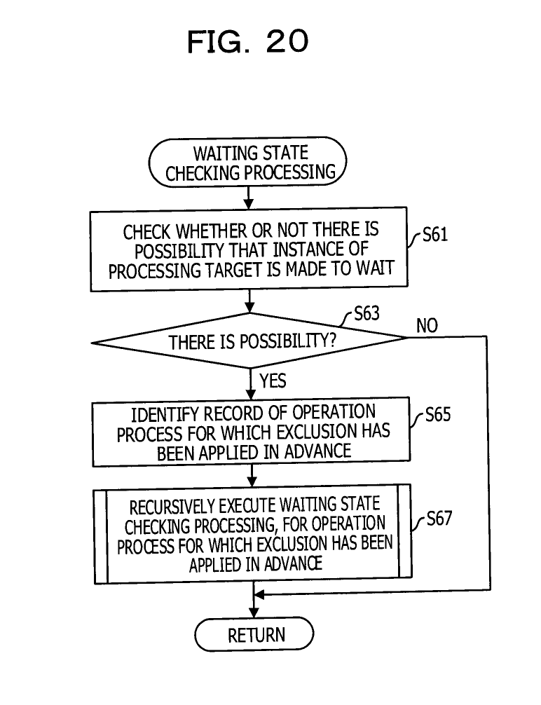

A case in which exclusion waiting occurs is described with reference to FIGS. 19 to 43. Here, the processing content of Step S35 is described with reference to FIGS. 19 and 20.

The operation process state management unit 130 identifies the state of an instance that is a processing target (FIG. 19: Step S51).

For example, the operation process state management unit 130 reads pieces of data on a waiting number and a waiting state of a record of an instance at “t=t−1”, from the instance management table. Nothing is registered initially, so that the operation process state management unit 130 identifies an exclusive condition from the start management table and the exclusion management table, and determines whether or not exclusion waiting occurs, from the exclusive condition. There is a case in which new exclusion waiting occurs, so that the operation process state management unit 130 executes processing of identifying an exclusive condition from the exclusion management table, and checking whether or not new exclusion occurs for a further instance that exists at “t=t−1”.

After that, the operation process state management unit 130 executes waiting state checking processing (Step S53). The detail of the waiting state checking processing is described later.

In addition, the operation process state management unit 130 decides the waiting state in an instance that is a processing target, from the detected waiting state (Step S55). For example, the operation process state management unit 130 identifies a case in which the waiting is resolved, and a case in which the waiting occurs, at the specified time (after t unit times). When the waiting has been resolved, the execution is started, so that the flow transitions to the next operation module. In the case in which the waiting has occurred, an instance by which the waiting is caused to occur is identified.

The waiting state checking processing is described below with reference to FIG. 20.

The operation process state management unit 130 checks whether or not there is a possibility that the instance that is the processing target is made to wait (Step S61). In the instance management table, it is determined whether or not a waiting number is registered in a focused record.

When there is no possibility that the instance is made to wait (Step S63: No route), the processing returns to the processing of the calling source.

On the other hand, there is a possibility that the instance is made to wait (Step S63: Yes route), the operation process state management unit 130 identifies a record of the time t, which is related to an instance of an operation process for which exclusion has been applied in advance (Step S65). In addition, the operation process state management unit 130 recursively executes the waiting state checking processing, for the instance of the operation process for which the exclusion has been applied in advance (Step S67). In addition, the processing returns to the processing of the calling source.

When the processing is executed as described above, an exclusive relationship is checked until it is determined that there is no possibility that exclusion occurs.

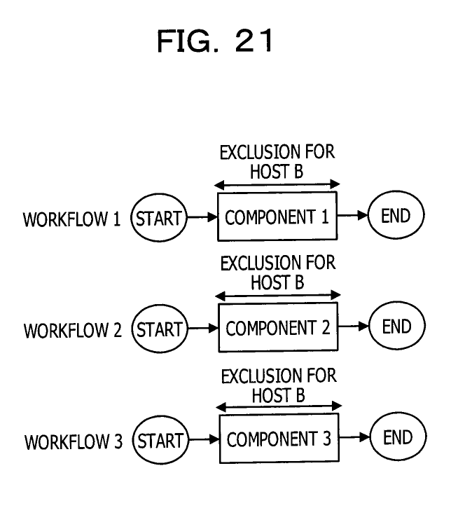

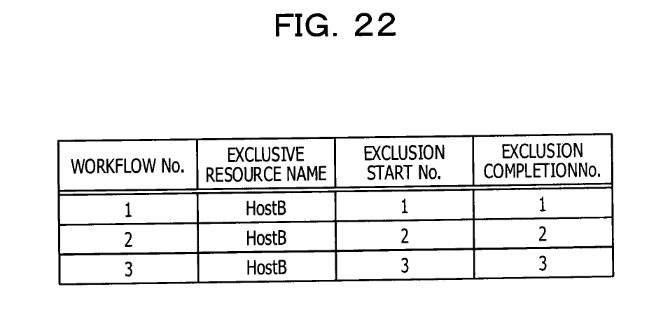

For example, the specific example as illustrated in FIG. 21 is considered. In the example of FIG. 21, a case in which workflows 1 to 3 are executed in parallel is assumed, and a component 1 is included in the workflow 1, and a component 2 is included in the workflow 2, and a component 3 is included in the workflow 3. As an exclusive condition, to each of the components 1 to 3, exclusion for a host B is set. Thus, the state of the exclusion management table becomes the state illustrated in FIG. 22. That is, to the component of each of the workflows, the host B is set as an exclusive resource name.

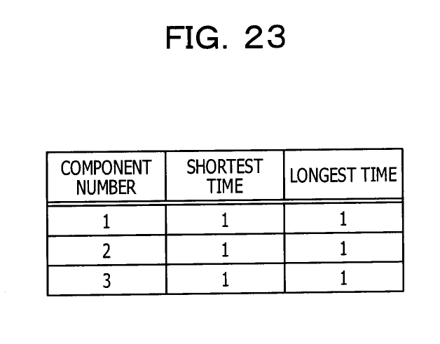

In addition, it is assumed that the execution time management table as illustrated in FIG. 23 is stored in the database 120. In the example of FIG. 23, the execution time of any component is simplified as one second.

It is assumed that the start times are the same in such an example as well, and the description of the start time table is omitted herein.

In the case of the exclusion management table as illustrated in FIG. 22, when the attention is focused on the workflow 1, the exclusive condition is overlapped with those of the workflows 2 and 3, so that there is a possibility that waiting may occur in the workflows 2 and 3.

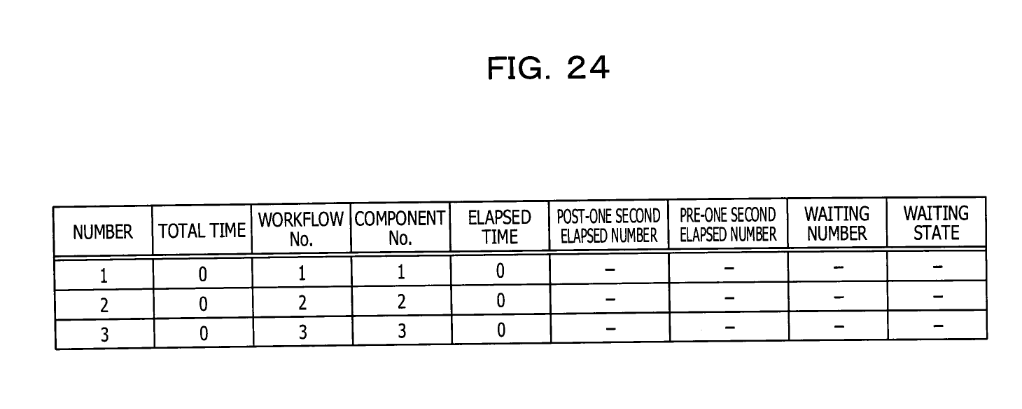

At “t=0”, the state of the instance management table becomes the state illustrated in FIG. 24. The state of any workflow becomes the state in which the flow has transitioned to the initial processing of a component in Step S43. In the state decision processing, it is assumed that waiting is not identified initially.

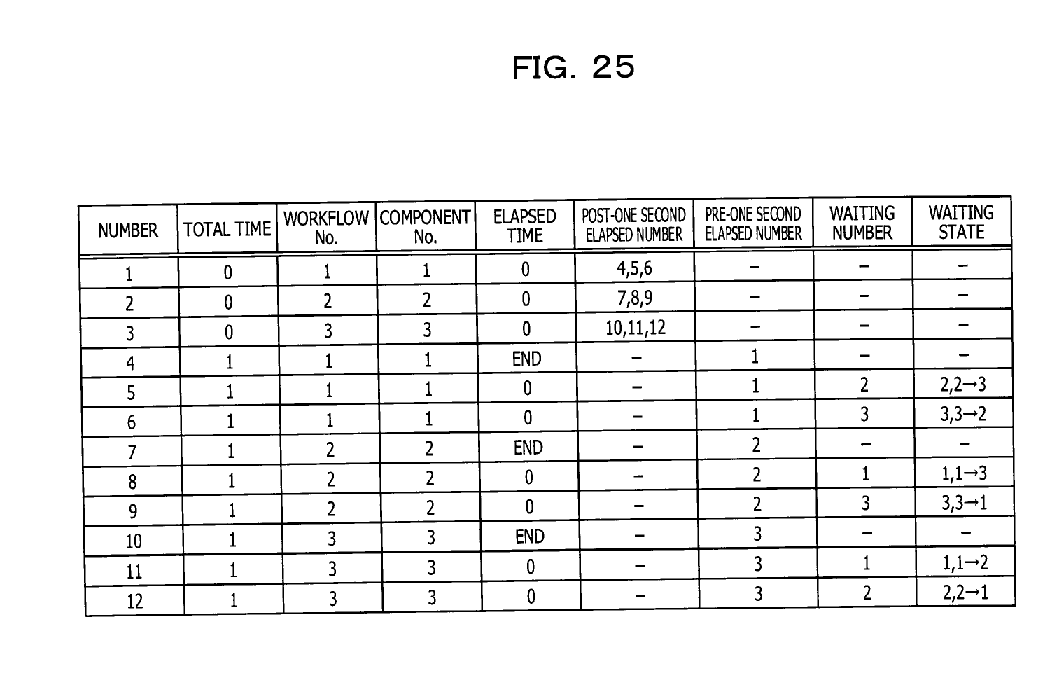

At “t=1”, the state of the instance management table becomes the state illustrated in FIG. 25.

In the instance indicated by the record having the record number “1”, the execution time of the component 1 is one second, and non-completion of the component does not occur as long as the execution is performed, so that creation of a record is not performed in Step S33. In the state decision processing, it is determined whether or not exclusion waiting occurs, from an exclusive condition that has been set for a further workflow, in the exclusion management table in Step S51. In the case of the exclusion management table illustrated in FIG. 22, waiting does not occur as long as the workflow 1 is executed first. On the other hand, it is understood that the workflow 1 has an exclusive relationship with the component 2 of the workflow 2 and the component 3 of the workflow 3. Thus, exclusion waiting of the workflow 2 and exclusion waiting of the workflow 3 occur. However, the exclusion waiting of the workflow 2 may include a case in which the workflow 2 waits for the workflow 3. Similarly, the exclusion waiting in the workflow 3 may include a case in which the workflow 3 waits for the workflow 2. Such a state is identified. In the record having the record number “1” in “t=0”, a waiting number is not registered, so that it is determined that there is no possibility that waiting occurs.

Thus, in Step S39, the record of the instance in the case of waiting of the workflow 2 (record number “5”), and the record of the instance in the case of waiting of the workflow 3 (record number “6”) are generated. As described above, even in the case of waiting of the workflow 2, there are a case in which the workflow 2 is merely made to wait and a case in which the workflow 2 waits for the workflow 3, so that the state is registered in the cell of the waiting state. Here, “2→3” indicates the state in which the workflow 2 waits for the workflow 3. Similarly, even in the case of waiting of the workflow 3, there are a case in which the workflow 3 is merely made to wait and a case in which the workflow 3 waits for the workflow 2, so that the state is registered in the cell of the waiting state.

In addition, in Step S43, a record of the instance in which the component 1 of the workflow 1 is executed first and the processing ends (record number “4”) is created in the instance management table.

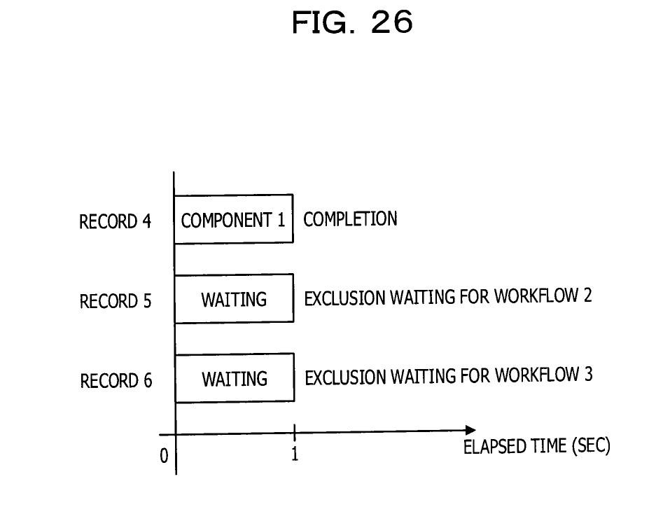

The state of the instance of the workflow 1 at “t=1” is schematically illustrated in FIG. 26.

In the specific example, the same determination is performed on the record “2” for the workflow 2 and the record “3” for the workflow 3.

For the workflow 2, the records “8” and “9” are generated in Step S39, the record “7” is generated in Step S43. The record “8” indicates the instance of waiting of the workflow 1, but includes the state in which the workflow 1 is merely made to wait and the state in which the workflow 1 waits for the workflow 3. Similarly, the record “9” indicates the instance of waiting of the workflow 3, but includes the state in which the workflow 3 is merely made to wait and the state in which workflow 3 waits for the workflow 1.

In addition, for the workflow 3, records “11” and “12” are generated in Step S39, and a record “10” is generated in Step S43. The record “11” indicates the instance of waiting of the workflow 1, but includes the state in which the workflow 1 is merely made to wait and the state in which the workflow 1 waits for the workflow 2. Similarly, the record “12” indicates the instance of waiting of the workflow 2, but the state in which the workflow 2 is merely made to wait and the state in which the workflow 2 waits for the workflow 1.

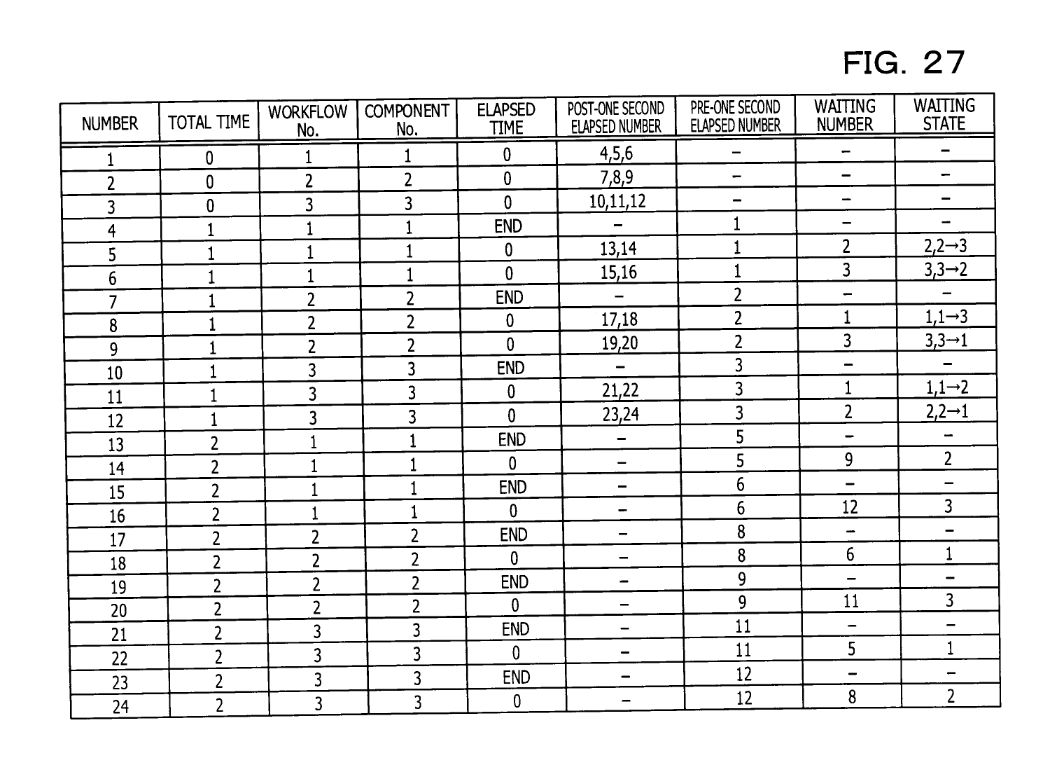

After that, at “t=2”, the state of the instance management table becomes the state illustrated in FIG. 27. At “t=2”, the records “5”, “6”, “8”, “9”, “11”, and “12” are processing targets.

When the attention is focused on the instance of the record “5”, the execution is not started yet, so that creation of a record indicating non-completion in Step S33 is not performed.

On the other hand, in the cell of the waiting state, the state before one second elapses is registered, so that the state is identified in Step S51. In Step S61, the record “2” is created in the cell of the waiting number, so that it is determined that there is a possibility of exclusion waiting occurring in Step S63. Therefore, “7”, “8”, and “9” are created in the cell of the post-one second elapsed number in the records “2”, so that these records are identified in Step S65. In Step S67, for each of the identified three records, the waiting state checking processing is recursively executed.

When the attention is focused on the record “7”, the record has ended, so that there is no possibility that waiting occurs, that is, the waiting has been resolved. When the attention is focused on the record “8”, it is indicated that “1” is registered in the cell of the waiting number. However, the current processing target record is the record for the workflow 1, so that the record “8” is not considered, and it is determined that there is no possibility of exclusion waiting occurring. When the attention is focused on the record “9”, it is understood that “3” is registered in the cell of the waiting number. Here, it is detected that there is a possibility of exclusion waiting occurring, in Step S63.

Therefore, in Step S65, the records “10”, “11”, and “12” that have been created in the cell of the post-one second elapsed number are identified, with reference to the record “3”. In addition, for each of these records, in Step S67, the waiting state checking processing is recursively executed.

When the attention is focused on the record “10”, the record has ended, so that there is no possibility that waiting occurs. That is, the waiting has been resolved. When the attention is focused on the record “11”, it is understood that “1” is registered in the cell of the waiting number. However, originally, the exclusion waiting for the workflow 1 is determined, so that the record “11” is not considered, and it is determined that there is no possibility that the exclusion waiting occurs. When the attention is focused on the record “12”, it is understood that “2” is registered in the cell of the waiting number. However, the record “9” for the workflow 2 is a processing target record, so that the record “12” is not considered, and it is determined that there is no possibility of exclusion waiting occurring. As described above, the exclusion waiting of the instance of the record “9” has been resolved.

Therefore, the processing returns to Step S55, and for the record “5”, there are a case in which the waiting has been resolved, based on the record “7”, and a case of waiting of the workflow 2 based on the record “9”. However, the case of the waiting of the workflow 2 includes the state in which the workflow 2 is merely made to wait, and the state in which the workflow 2 waits for the workflow 3, but the latter case has been resolved, and the former case is merely left. Thus, for the record “5”, the instance waiting of the record “9” for the workflow 2 is decided. The state in which the waiting has been resolved for the record “7” is also identified.

Therefore, a record “13” indicating that the waiting has been resolved based on the record “7”, and the component 1 has been executed, and the processing has been completed is created in the instance management table in Step S43. Similarly, a record “14” indicating the state in which the record “9” is made to wait is also created in the instance management table in Step S39. The workflow “2” is registered in the cell of the waiting state of the record “14” because it is assumed that the workflow 2 is merely made to wait as described above.

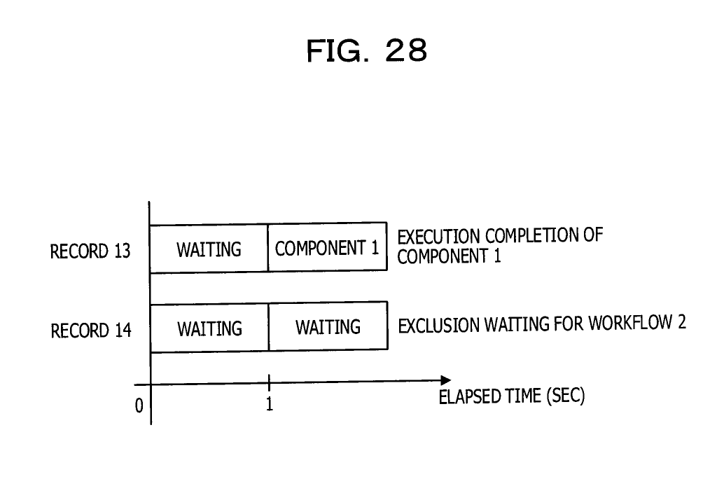

The processing for the above-described record “5” is summarized as illustrated in FIG. 28. That is, the completion of the component 2 of the workflow 2 has been made to wait, but the execution of the component 2 of the workflow 2 has been completed, so that the record “13” is generated that indicates that the component 1 of the workflow 1 has been executed and has ended. In addition, the workflow 2 that has made to wait for the workflow 3 is not completed yet, so that a record “14” is also generated that indicates the completion of the workflow 2 is made to wait.

Such processing is also executed for each of the records “6”, “8”, “9”, “11”, and “12”.

In the record “6”, there are a case in which the waiting has been resolved, based on the record “10” and a case of waiting of the workflow 3, based on the record “12”. However, the case of the waiting of the workflow 3 includes the state in which the workflow 3 is merely made to wait, and the state in which the workflow 3 waits for the workflow 2, but the latter case has been resolved, and the former case is merely left. Thus, the instance waiting of the record “12” for the workflow 3 is decided. The state in which the waiting has been resolved for the record “10” is also identified.

Therefore, a record “15” indicating that the waiting has been resolved based on the record “10”, and the component 1 has been executed, and the processing has been completed, is created in the instance management table in Step S43. Similarly, a record “16” indicating the state in which the record “12” is made to wait is also created in the instance management table in Step S39. The workflow “3” is registered in the cell of the waiting state of the record “16” because it is assumed that the workflow 3 is merely made to wait as described above.

In the record “8”, there are a case in which the waiting has been resolved, based on the record “4”, and a case of waiting of the workflow 1 based on the record “6”. However, the case of the waiting of the workflow 1 includes the state in which the workflow 1 is merely made to wait, and the state in which the workflow 1 waits for the workflow 3, but the latter case has been resolved, and the former case is merely left. Thus, the instance waiting of the record “6” for the workflow 1 is decided. The state in which the waiting has been resolved for the record “4” is also identified.

Therefore, a record “17” indicating that the waiting has been resolved based on the record “4”, and the component 2 has been executed, and the processing has been completed, is created in the instance management table in Step S43. Similarly, a record “18” indicating the state in which the record “6” is made to wait is also created in the instance management table in Step S39. The workflow “1” is registered in the cell of the waiting state of the record “18” because it is assumed that the workflow 1 is merely made to wait as described above.

In the record “9”, there are a case in which the waiting has been resolved, based on the record “10”, and a case of waiting of the workflow 3 based on the record “11”. However, the case of the waiting of the workflow 3 includes the state in which the workflow 3 is merely made to wait, and the state in which the workflow 3 waits for the workflow 1, but the latter case has been resolved, and the former case is merely left. Thus, the instance waiting of the record “11” for the workflow 3 is decided. The state in which the waiting has been resolved for the record “10” is also identified.

Therefore, a record “19” indicating that the waiting has been resolved based on the record “10”, and the component 2 has been executed, and the processing has been completed, is created in the instance management table in Step S43. Similarly, a record “20” indicating the state in which the record “11” is made to wait is also created in the instance management table in Step S39. The workflow “3” is registered in the cell of the waiting state of the record “20” because it is assumed that the workflow 3 is merely made to wait as described above.

In the record “11”, there are a case in which the waiting has been resolved, based on the record “4”, and a case of waiting of the workflow 1 based on the record “5”. However, the case of the waiting of the workflow 1 includes the state in which the workflow 1 is merely made to wait, and the state in which the workflow 1 waits for the workflow 2, but the latter case has been resolved, and the former case is merely left. Thus, the instance waiting of the record “5” for the workflow 1 is decided. The state in which the waiting has been resolved for the record “4” is also identified.

Therefore, a record “21” indicating that the waiting has been resolved based on the record “4”, and the component 3 has been executed, and the processing has been completed, is created in the instance management table in Step S43. Similarly, a record “22” indicating the state in which the record “5” is made to wait is also created in the instance management table in Step S39. The workflow “1” is registered in the cell of the waiting state of the record “22” because it is assumed that the workflow 1 is merely made to wait as described above.

In the record “12”, there are a case in which the waiting has been resolved, based on the record “7”, and a case of waiting of the workflow 2 based on the record “8”. However, the case of the waiting of the workflow 2 includes the state in which the workflow 2 is merely made to wait, and the state in which the workflow 2 waits for the workflow 1, but the latter case has been resolved, and the former case is merely left. Thus, the instance waiting of the record “8” for the workflow 2 is decided. The state in which the waiting has been resolved for the record “7” is also identified.

Therefore, a record “23” indicating that the waiting has been resolved based on the record “7”, and the component 3 has been executed, and the processing has been completed, is created in the instance management table in Step S43. Similarly, a record “24” indicating the state in which the record “8” is made to wait is created in the instance management table in Step S39. The workflow “2” is registered in the cell of the waiting state of the record “24” because it is assumed that the workflow 2 is merely made to wait as described above.

The description of the subsequent processing is omitted herein.

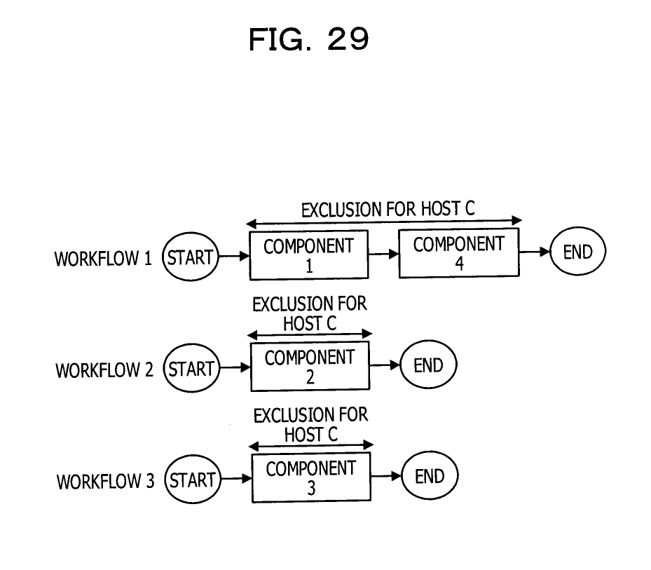

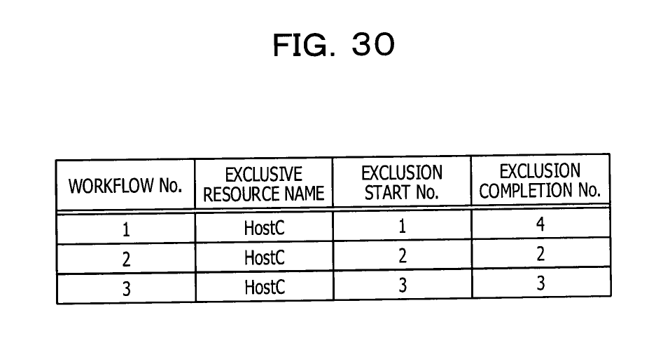

In addition, a further specific example is described below with reference to FIGS. 29 to 41. FIG. 29 illustrates a configuration example of workflows. A workflow 1 includes components 1 and 4. A workflow 2 includes a component 2. A workflow 3 includes a component 3. In the workflow 1, an exclusive condition for a host C is set to the component 1 and 4, and in the workflow 2, an exclusive condition for the host C is set to the component 2, and in the workflow 3, an exclusive condition for the host C is set to the component 3. That is, the state of the exclusion management table becomes the state illustrated in FIG. 30. Here, it is understood that the exclusive resource has common settings.

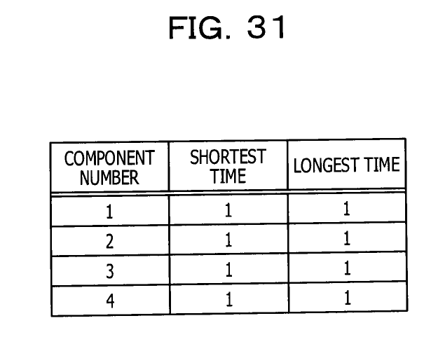

In addition, in the execution time table for the specific example, as illustrated in FIG. 31, it is assumed that the execution time is set at one second for any component.

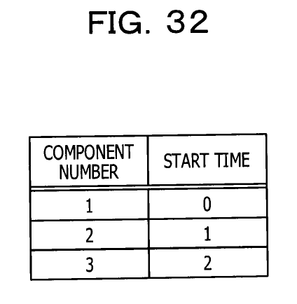

In the specific example, the start time is different depending on a workflow. This is defined in the start management table of the database 120. In the specific example, as illustrated in FIG. 32, it is assumed that, the execution of the workflow 1 is started immediately, and the execution of the workflow 2 is started after one second has elapsed, and the execution of the workflow 3 is started after two seconds. Specification of such relative times may be applied.

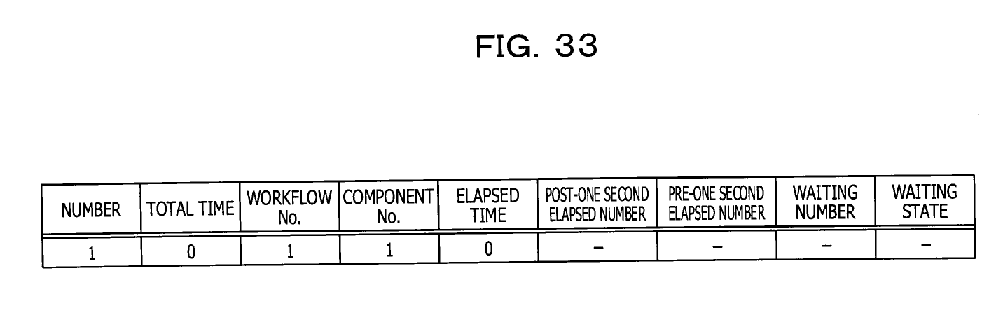

At “t=0”, a prediction instruction is issued merely to the operation process state management unit 130 that manages the workflow 1. Therefore, the data illustrated in FIG. 33 is registered in the instance management table.

At “t=0”, due to the state in which the execution of the workflow 1 is about to start, exclusion waiting does not occur, and the elapsed time is 0.

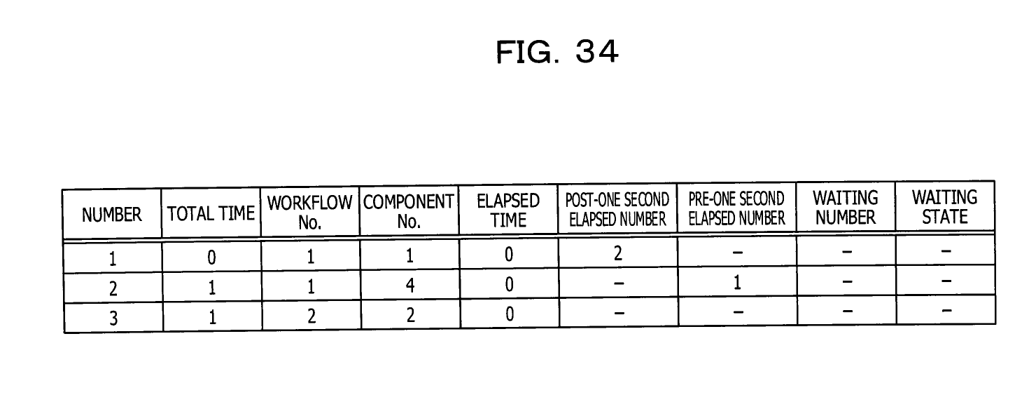

At “t=1”, a prediction instruction is also issued to the operation process state management unit 130 that manages the workflow 2. Therefore, the data illustrated in FIG. 34 is registered in the instance management table.

The record “2” indicates the state after one second has elapsed from the record “1”. For example, the execution of the component 1 is completed in one second, so that the record “2” indicating that the flow transitions to the component 4 is generated in Step S43.

In addition, the record “3” indicates the state in which the flow has transitioned to the initial processing of a component in Step S43, for the workflow 2. In the state decision processing, it is assumed that waiting is not identified initially.

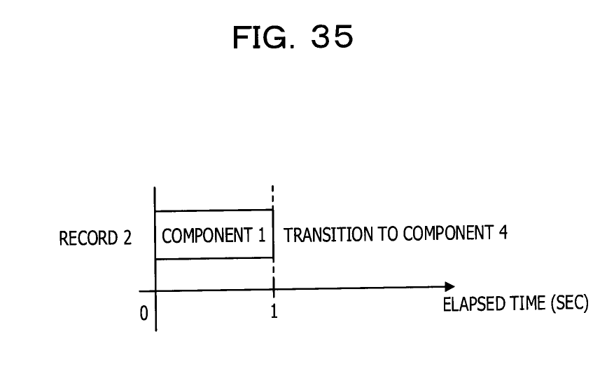

The state of “t=1” is schematically illustrated in FIG. 35. As illustrated in FIG. 35, for the workflow 1, the processing of the component 1 is completed, and the flow transitions to the processing of the component 4. In the workflow 2, the execution is not performed.

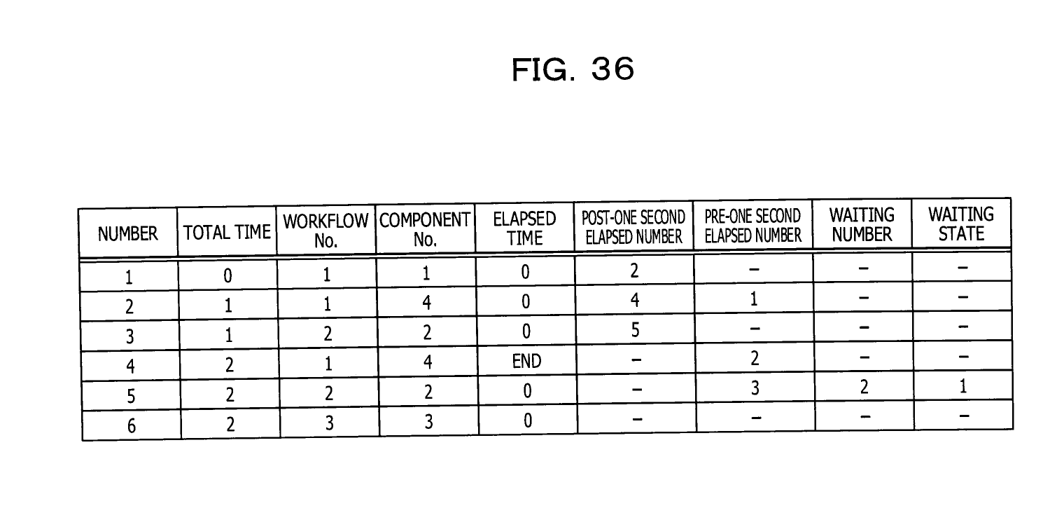

At “t=2”, a prediction instruction is also issued to the operation process state management unit 130 that manages the workflow 3. Therefore, the data illustrated in FIG. 36 is registered in the instance management table.

After one second has elapsed from the record “2”, the processing of the component 4 in the workflow 1 is completed, so that the record “4” is created in Step S43, and registered in the instance management table.

In addition, when the processing is executed for the record “3” in Step S51, in the workflow 2, occurrence of exclusion waiting for the workflow 1 is detected. Also, in the workflow 3, exclusion waiting may occur, but at “t=1”, due to the state in which a record is not generated yet, exclusion waiting does not occur in the workflow 3. Therefore, at “t=2”, the record “5” indicating that the record “2” for the workflow 1 is made to wait is created in Step S39, and registered in the instance management table.

In addition, the record “6” indicates the state in which the flow transitions to the initial processing of a component in Step S43, for the workflow 3. In the state decision processing, it is assumed that the waiting is not identified initially.

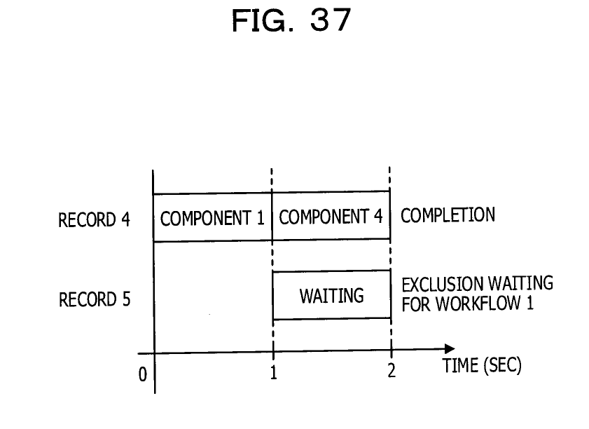

The state of “t=2” is schematically illustrated in FIG. 37. As illustrated in FIG. 37, for the instances of the workflow 1, the processing of the component 1 and the processing of the component 4 are completed. On the other hand, for the instance of the workflow 2, exclusion waiting for the workflow 1 occurs.

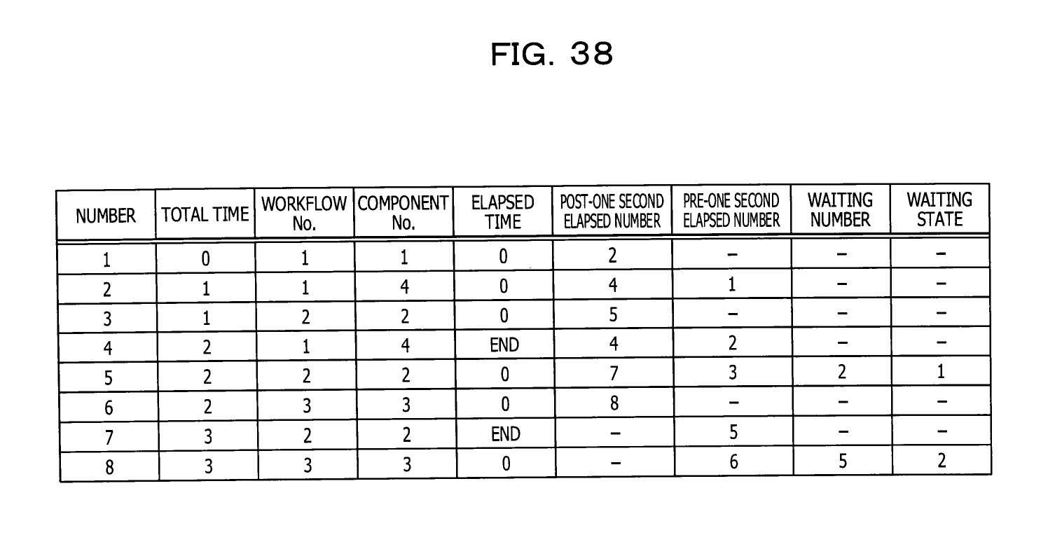

At “t=3”, the data illustrated in FIG. 38 is registered in the instance management table.

When the processing for the record “5” of the workflow 2 is executed, it is understood that the waiting for the workflow 1 occurs. In addition, the record “2” is registered in the cell of the waiting number, so that it is determined that there is a possibility that waiting may further occur. As the post-one second elapsed number, “4” is identified with reference to the record “2”. The record “4” indicates that the component 4 of the workflow 1 has been completed. As described above, it is determined that the exclusion waiting for the workflow 1 has been resolved. Therefore, in Step S43, the record “7” indicating the processing of the component 2 of the workflow 2 has been completed is created in the instance management table.

In addition, when the processing is executed for the record “6” of the workflow 3 in Step S51, occurrence of exclusion waiting for the workflow 2 is detected. The exclusion waiting may occur even for the workflow 1, but at “t=2”, the processing has been already completed, so that exclusion waiting does not occur for the workflow 1. Therefore, at “t=3”, the record “8” indicating that the record “5” for the workflow 2 is made to wait is created in Step S39, and registered in the instance management table.

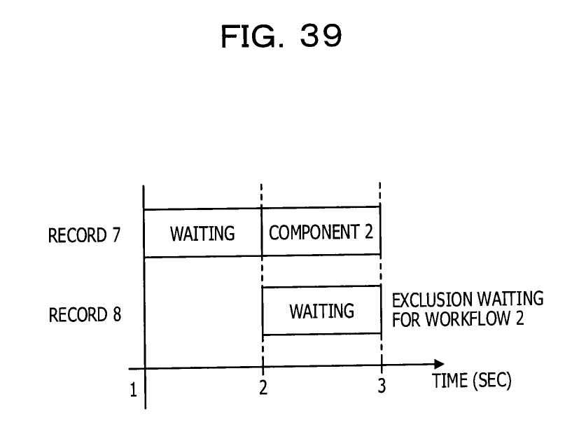

The state of “t=3” is schematically illustrated in FIG. 39. The record “7” indicates that, the component 2 is executed after one second has elapsed from the start time “1” of the workflow 2. On the other hand, in the record “8”, exclusion waiting for the workflow 2 occurs for one second from the start time “2” of the workflow 3.

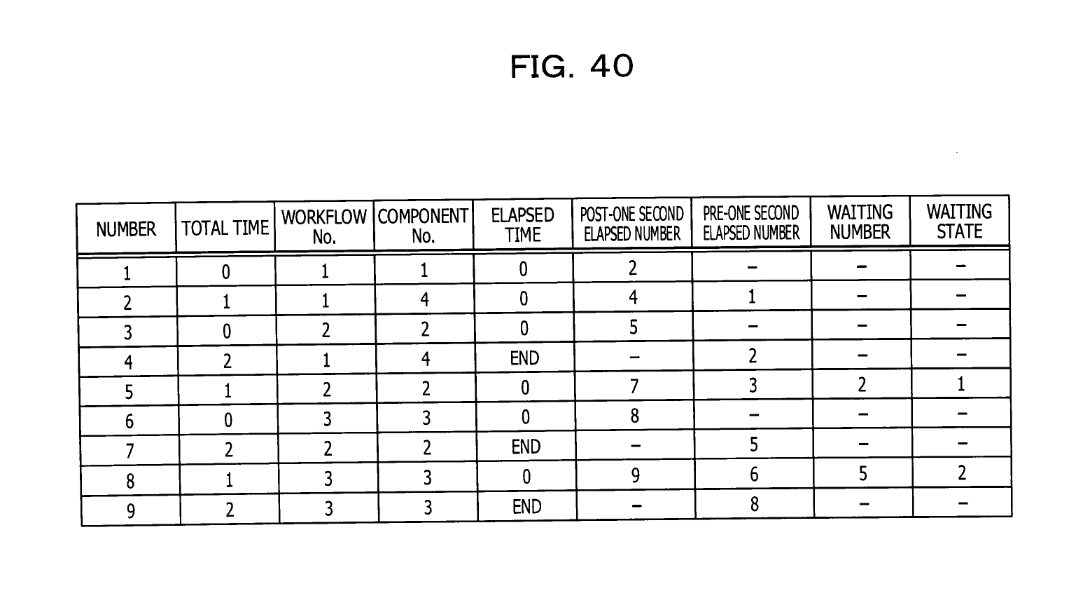

At “t=4”, the data illustrated in FIG. 40 is registered in the instance management table.

When the record “8” for the workflow 3 is referred to, it is understood that the waiting for the workflow 2 occurs. In addition, the record “5” is registered in the cell of the waiting number, so that it is determined that there is a possibility that waiting may further occur. Here, “7” is identified as the post-one second elapsed number with reference to the record “5”. The record “7” indicates that the component 2 of the workflow 2 has been completed. As described above, it is determined that the exclusion waiting for the workflow 2 has been resolved. Therefore, in Step S43, the record “9” indicating that the processing of the component 3 of the workflow 3 has been completed is created in the instance management table.

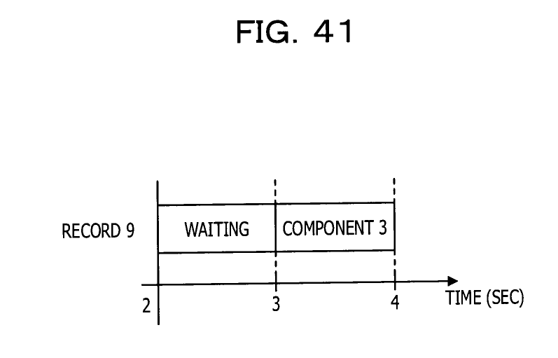

The state of “t=4” is schematically illustrated in FIG. 41. The record “9” indicates that the component 3 is executed after one second has elapsed from the start time “2” of the workflow 3.

As described above, when a plurality of workflows is executed in parallel, an instance for each of the workflows is additionally generated depending on an execution time and branching, and an appropriate waiting time may be reflected on the execution time by recursively tracing exclusion waiting for a further workflow.

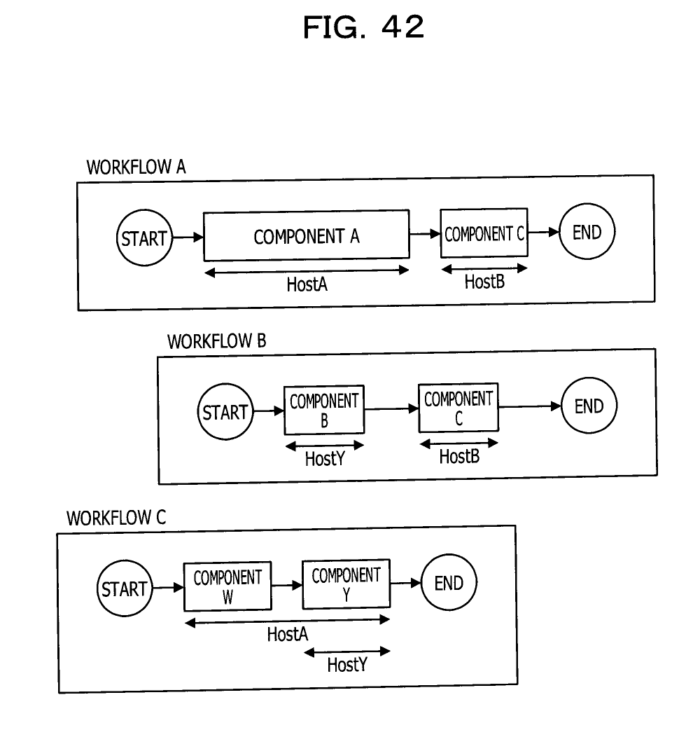

For example, even a case in which a complicated exclusive relationship of the workflows as illustrated in FIG. 42 is set may be dealt with. In the example of FIG. 42, an identical host A is set to a component A of a workflow A and components W and Y of a workflow C, as an exclusive resource, and an identical host Y is set to a component B of a workflow B and the component Y of the workflow C as an exclusive resource. In addition, an identical host B is set to a component C of the workflow A and a component C of the workflow B, as an exclusive resource.

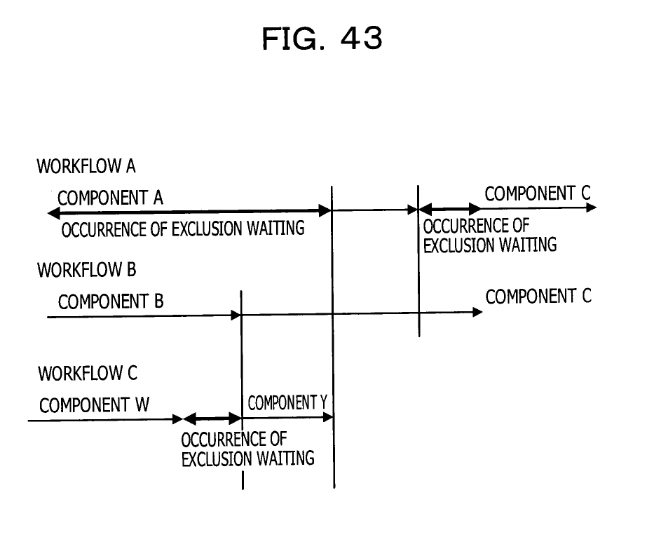

In such a case, as schematically illustrated in FIG. 43, when the execution of the component W of the workflow C is started early, exclusion waiting occurs in the component A of the workflow A. In a case in which the execution of the component B of the workflow B starts earlier than the execution of the component Y of the workflow C, even when the execution of the component W of the workflow C is completed, waiting occurs in the execution of the component Y. Therefore, the component A of the workflow A has been exclusively made to wait for the component W of the workflow C, but after that, the exclusion waiting for the component Y also occurs to be overlapped with the waiting for the component W of the workflow C. Such overlapping of exclusion waiting is indicated by a record created in the instance management table by recursively executing the waiting state checking processing.

After that, when the execution for the component B of the workflow B has been completed, resolution of the exclusion waiting in the component Y of the workflow C is detected, and the component Y of the workflow C is executed. When the execution of the component Y of the workflow C has been completed, resolution of the exclusion waiting in the component A of the workflow A is detected, and the component A of the workflow A is executed.

Even when the execution of the component A of the workflow A is completed, exclusion waiting for the component C of the workflow B is detected in the component C of the workflow A. After that, when the processing of the component C of the workflow B has been completed, resolution of the exclusion waiting in the component C of the workflow A is detected, and the component C of the workflow A is executed.

In FIG. 43, an exclusive relationship is illustrated simply by assuming that the execution times are the same, but in a case in which a range is set to the execution time, an instance is generated for each of the execution times, and various exclusion waiting states are generated. Even in such a case, an instance is generated depending on a situation, and is simulated accurately with the time progress, so that an accurate execution time may be estimated.

Though the description is omitted above, but the shortest time and the longest time of the execution time are mainly focused, so that there is a case in which a record of an instance that is obviously not related to calculation of the shortest time and the longest time is discarded in the middle of processing.

In addition, in the above description, it is assumed that the execution time of each of the components is set in advance, but the execution time may be estimated from a parameter such as the processing capacity of a server or the like in which the workflow is actually executed.

The embodiments are described above, but the technology discussed herein is not limited to such embodiments. For example, in the processing flow, the processing order may be changed or a plurality of steps may be executed in parallel as long as the processing result is not changed. In addition, even the function block configuration of the information processing device 100 illustrated in FIG. 2 is merely an example, and may be different from the program module configuration.

In addition, the information processing device 100 may be constituted by a plurality of computers, instead of a single computer.

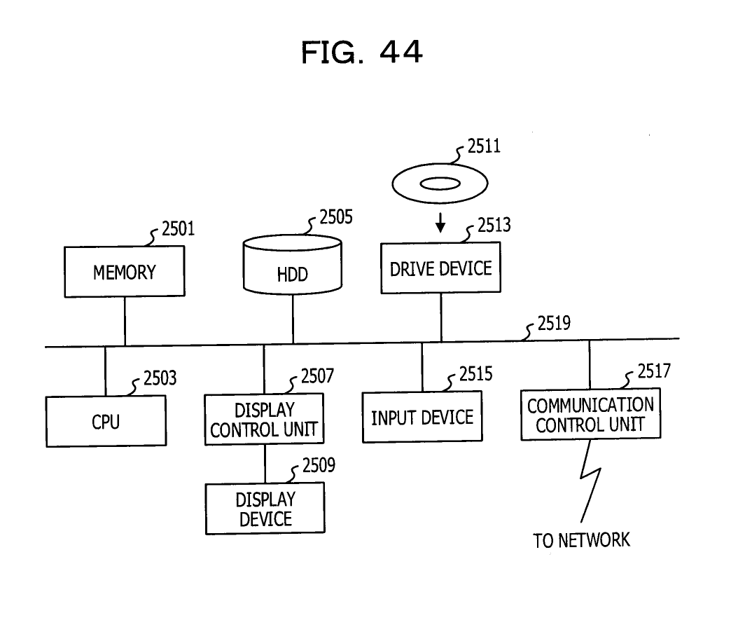

The above-described information processing device 100 is a computer device, and as illustrated in FIG. 44, in the information processing device 100, a memory 2501, a central processing unit (CPU) 2503, a hard disk drive (HDD) 2505, a display control unit 2507 coupled to a display device 2509, a drive device 2513 for a removable disk 2511, an input device 2515, and a communication control unit 2517 used to perform connection with a network are coupled to each other through a bus 2519. An operating system (OS) and an application program used to execute the processing in the embodiment are stored in the HDD 2505, and read from the HDD 2505 to the memory 2501 when being executed by the CPU 2503. The CPU 2503 cause a certain operation to be executed by controlling the display control unit 2507, the communication control unit 2517, and the drive device 2513 depending on processing content of the application program. In addition, data in the middle of processing is mainly stored in the memory 2501, but may be stored in the HDD 2505. In the embodiments, the application program used to execute the above-described processing is distributed to be stored in the computer-readable removable disk 2511, and installed into the HDD 2505 from the drive device 2513. The application program may be installed into the HDD 2505 through a network such as the Internet and the communication control unit 2517. Such a computer device achieves the above-described various functions by organic cooperation between the hardware such as the above-described CPU 2503 and the memory 2501, and the program such as the OS and the application program.

The above-described embodiments are summarized as follows.

An execution time estimation device according to an embodiment is an execution time estimation device that estimates an execution time when a plurality of processes, each of which includes one or plurality of modules, is executed. In addition, such an execution time estimation device includes (A) a storage unit configured to store a condition of exclusive execution for the plurality of processes, and data on a range of execution time in each of the modules included in each of the plurality of processes, (B) an estimation unit that estimates an execution time when the plurality of processes is executed by executing case processing so as to cause simulation of the case processing to progress, and the case processing includes (b1) generating one or more cases, based on the range of the execution time of each of the modules, which is stored in the storage unit, in order of the modules included in each of the processes, for each of the plurality of processes, (b2) executing first determination processing of determining a presence or absence of occurrence of exclusion waiting between the plurality of cases of the plurality of processes, based on the above-described condition stored in the storage unit, and setting exclusion waiting for a case of a process in which the exclusion waiting occurs when it is determined that the exclusion waiting occurs. In this case, the above-described first determination processing includes second determination processing of determining a presence or absence of a possibility that the exclusion waiting may occur, and processing of determining the presence or absence of the occurrence of the exclusion waiting, based on a processing result of the second determination processing. In addition, in the above-described first determination processing, when there is the possibility that the exclusion waiting may occur in the second determination processing, the second determination processing is recursively executed for the case in which there is the possibility that the exclusion waiting may occur.

As described above, in a case in which the range of the execution time is set to each of the modules, one or plurality of cases (instances in the embodiments) that correspond to the execution time are generated at any time (or dynamically), so that exclusion waiting may occur, or exclusion waiting may not occur. In addition, exclusion waiting overlapping with each other may occur depending on a case. When the above-described processing is executed, such a complicated situation may be dealt with, so that the execution time may be estimated accurately. When a plurality of execution times is estimated, the shortest time and the longest time may be identified from the plurality of execution times. Therefore, it may be determined accurately whether or not a plurality of processes is allowed to be completed until a certain time.

When there is branching in any one of the plurality of processes, the above-described case processing may include processing of generating a case of the process, for each branching destination. Therefore, various cases may be dealt with.

In addition, there is a case in which data on start timing of the plurality of processes is further stored in the above-described storage unit. In this case, the above-described estimation unit may generate a case for each of plurality of processes depending on start timing. When there is a deviation between start timing of workflows, the presence or absence of exclusion waiting is affected, so that the execution time may be estimated accurately as long as the control is performed as described above.

In addition, there is also a case in which data on an execution timing for a module that desires human power, which is included in at least some of the plurality of processes is included in the above-described storage unit. In such a case, in the above-described estimation unit, the flow transitions to the module that desires manpower, and a case of a process that includes the module that desires manpower may be treated as a case in which waiting occurs until the execution timing. Even the module that desires manpower may be dealt with using a variation in the execution times similar to the other modules, or may be defined by the execution timing.

A program may be created that is used to cause the processor or computer to execute the above-described processing, and the program is stored, for example, in a computer-readable storage medium or a storage device such as a flexible disk, an optical disk of a CD-ROM, a magneto-optical disk, a semiconductor memory (for example, a ROM), or a hard disk. Data that is in the middle of processing is temporarily stored in a storage device such as a RAM.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A device for estimating an entire execution time when a plurality of processes, each of which includes one or more modules, is executed, the device comprising:
a memory configured to store a condition of exclusive execution for the plurality of processes, and execution time ranges of each of the one or more modules, the execution time ranges indicating from a shortest estimation time to a longest estimation time regarding each of execution times by the one or more modules; and
a processor configured to estimate the entire execution time by executing estimation processing so as to cause simulation of the estimation processing to progress, the estimation processing including:
generating one or more cases, for each of the plurality of processes, in order of the one or more modules based on the execution time ranges of each of the one or more modules,
determining whether there is a possibility that exclusion waiting occurs based on the condition, for each of the one or more cases, and
setting the exclusion waiting for a certain case in which it is determined that there is the possibility, from among the one or more cases.

2. The device according to claim 1, wherein
the processor is configured to recursively execute a processing of determining whether there is the possibility for the certain case.

3. The device according to claim 1, wherein
the processor is configured to generate, when branching exists in any one of the plurality of processes, a specific case regarding each branching destination.

4. The device according to claim 1, wherein
the memory is configured to store data regarding start timing of the plurality of processes, and
the processor is configured to generate the one or more cases depending on the start timing.

5. A method of estimating an entire execution time when a plurality of processes, each of which includes one or more modules, is executed, the method comprising:
estimating, by a processor, the entire execution time by executing estimation processing so as to cause simulation of the estimation processing to progress, the estimation processing including:
generating one or more cases, for each of the plurality of processes, in order of the one or more modules based on execution time ranges of each of the one or more modules, the execution time ranges indicating from a shortest estimation time to a longest estimation time regarding each of execution times by the one or more modules,
determining, for each of the one or more cases, whether there is a possibility that exclusion waiting occurs based on a condition of exclusive execution for the plurality of processes, and
setting the exclusion waiting for a certain case in which it is determined that there is the possibility, from among the one or more cases.

6. The method according to claim 5, further comprising:
recursively executing a processing of determining whether there is the possibility for the certain case.

7. The method according to claim 5, further comprising:
generating, when branching exists in any one of the plurality of processes, a specific case regarding each branching destination.

8. The method according to claim 5, wherein the one or more cases is generated further based on start timing of the plurality of processes.

9. A non-transitory computer-readable recording medium storing a program for causing a computer to execute a procedure for estimating an entire execution time when a plurality of processes, each of which includes one or more modules, is executed, the procedure comprising:
estimating, by a processor, the entire execution time by executing estimation processing so as to cause simulation of the estimation processing to progress, the estimation processing including:
generating one or more cases, for each of the plurality of processes, in order of the one or more modules based on execution time ranges of each of the one or more modules, the execution time ranges indicating from a shortest estimation time to a longest estimation time regarding each of execution times by the one or more modules,
determining, for each of the one or more cases, whether there is a possibility that exclusion waiting occurs based on a condition of exclusive execution for the plurality of processes, and
setting the exclusion waiting for a certain case in which it is determined that there is the possibility, from among the one or more cases.

10. The non-transitory computer-readable recording medium according to claim 9, the procedure further comprising:
recursively executing a processing of determining whether there is the possibility for the certain case.

11. The non-transitory computer-readable recording medium according to claim 9, the procedure further comprising:
generating, when branching exists in any one of the plurality of processes, a specific case regarding each branching destination.

12. The non-transitory computer-readable recording medium according to claim 9, wherein the one or more cases is generated further based on start timing of the plurality of processes.
